(19) United States
(12) Patent Application Publication
(10) Pub. No.: US 2008/0102172 A1
(43) Pub. Date: May 1, 2008

(54) Frozen Confection and Holding Device

(75) Inventors: Martine Capelle, Beauvais (FR); Christian Dufort, Nontron (FR); Mohamed Adel Attia, Bakersfield, CA (US)

Correspondence Address: BELL, BOYD & LLOYD LLP, P.O. Box 1135, CHICAGO, IL, 60690, US

(73) Assignee: Nestec S.A., Vevey (CH)

(21) Appl. No.: 11/574,293

(22) PCT Filed: Mar. 22, 2005
(86) PCT No.: PCT/EP05/03025

§ 371 Date: Sep. 7, 2007

(30) Foreign Application Priority Data
Aug. 27, 2004 (EP) 04020379.6

(51) Int. Cl. A23G 9/00; A23G 9/04

(52) U.S. Cl. 426/103; 426/115; 426/134; 426/393; 426/515

(57) ABSTRACT

Composite frozen confection comprising: a frozen confection holding device in the form of a stick container (1) filled with a dessert component that is liquid at low negative temperature and a body of frozen confection which is supported by the stick container (1) filled with dessert and in which the stick is anchored; A visual effect is produced on the frozen confection (6) upon consumption which can be a flow effect on the frozen confection surface, like a volcano; a hair effect over a clown face; a product expansion by effervescence on the surface of the frozen confection; a dispersion of solid additions at the surface of the frozen confection or a combination of the above effects.

### FIELD OF THE INVENTION

The present invention relates to novel ice confectionery products and to a method for preparing them.

More particularly the invention relates to a frozen confection holding device which dispenses an edible liquid filling from a reservoir, comprised within the holding device, upon consumption of the frozen confection and a composite frozen confection comprising such a holding device.

### BACKGROUND OF THE INVENTION

A hollow straw for holding a frozen confectionery block is known from U.S. Pat. No. 2,036,706 with the objective of lowering it into a glass of beverage, e.g. soda water and the beverage thereby made into an ice cream soda variety of drink for sucking through the straw. The hollow straw is projecting through the frozen confectionery block and may be closed at one or both of its ends.

A candy sucker with a liquid dispensing assembly is known from U.S. Pat. No. 5,324,527, wherein the sucker type candy has channels through which the liquid filling which is pushed out of a plastic housing passes and oozes out at the top of the candy.

It is an object of the invention to provide a frozen stick bar that is particularly attractive first to children secondly to adults in that it offers a fun and unique added senses-stimulus to the enjoyment of frozen dessert novelties upon consumption. This senses-stimulus is in the form of a unique visual effect and eating experience such as a fountain of liquid syrup, sauce, drink or mousse which may flow out from the top on and around the stick bar.

### SUMMARY OF THE INVENTION

The invention thus comprises a holding device for a frozen confection in the form of a stick container filled with a dessert component that is liquid at low negative temperature,
wherein the stick container is closed by a closure element or a closure mechanism which can be an intermediate or a final closure, edible or non-edible and wherein the stick container is capable of dispensing the dessert component on the surface of the frozen confection by reducing the internal volume of the stick container after removal of the closure element or opening the closure mechanism

The invention further relates to a composite frozen confection comprising:
a frozen confection holding device in the form of a stick container filled with a dessert component that is liquid at negative temperature and
a body of frozen confection which is supported by the stick filled with the dessert component and in which the stick is anchored.

The invention further relates to methods of manufacture of a composite frozen confection as described above.

The invention further relates to a method for dispensing a liquid dessert component over and around the surface of a frozen confection.

### DETAILED DESCRIPTION OF THE INVENTION

In the invention the stick container is an elongated hollow element and may be made of flexible but rigid food grade nonedible material or edible material or a combination of these materials. The nonedible materials preferably include plastics such as polypropylene or polyethylene. The stick container has to be warm to touch. The hollow element preferably has a bulb part which serves as a container for the liquid which is to be dispensed and may be a flexible pouch or balloon or a rigid plastic container of any material. Thus the holding device may comprise one, two or three or more parts which may be assembled together in the case of several parts.

The plastic stick container could be made in one part by any conventional forming method such as injection molding, injection blow molding, thermoforming, extrusion blow molding, injection extrusion or a combination of these forming methods. It may also be in two or three or more parts so as to comprise a hollow tube connected to and assembled with a flexible pouch or balloon. In another embodiment the hollow plastic stick may comprise a tube containing a slidable plunger, such as for example a syringe or be a collapsible telescopic tube. In still a further embodiment the holding device for the frozen confection may comprise a two pieces stick container comprising a hollow tube which is a part in a packaging envelope of the product which is formed of two cavities, one containing the flowable liquid dessert and the other serving as a mold for the frozen confection.

An edible material for the stick container may comprise any coated or uncoated sugar and/or chocolate confectionery such as for example a liquorice, a chewing gum, a chocolate coated hard candy, a pastry, a chocolate coated biscuit tube.

The stick container may also be a combination of such edible and nonedible parts as described therein.

The stick container may present a closure element or mechanism which could be an intermediate or a final closure, edible or non-edible.

In the invention the dessert component may be a sauce, a syrup, a jelly, honey, an alcohol, a carbonated or fizzy drink, a mousse.

Preferred dessert components are formulated to have specific rheological and mechanical properties. Preferred dessert components present particularly reduced freezing/melting temperatures that are sufficiently low that the said dessert is liquid at low negative temperatures and ready to be expressed in tasting at exit of the cabinet freezer.

Preferred dessert components present a Melting Temperature Range (Measurement by Differential Scanning Calorimetry (DSC), Cristallisation-Melting Isotherm Tests) of −16 to −40° C., more preferably from −20 to −35° C. Preferred dessert components present mechanical properties that does not show or shows low dilatation-contraction properties in an extended range of temperatures preferably from +20 to −40° C.

Moreover, preferred dessert components have a fluidity at negative temperature allowing to create a flow of the liquid over the surface of the frozen confection upon consumption. The dessert viscosity is dependant on the combination stick-sauce used and on the exit internal diameter of the stick.

Preferred dessert composition present a viscosity range of 1 to 400 Pa·s, preferably 1 to 100 Pa·s, at a negative temperature of −20° C. and a shear rate of 100 s−1, measured with a rheometer PHYSICA MCR 300.

To determine the Shear Viscosity a Rheometer PHYSICA MCR 300 is used with a Cone-Plate Geometry with a 50 mm diameter plate. The viscosity was measured at a temperature of −20° C., using a Shear rate of 100 s−1.

A suitable sauce or syrup preferably contains by weight:
0 to 20% water and more preferably 0 to 10% water,
30 to 95%, preferably 55 to 95% and more preferably 70 to 95% carbohydrates,
0 to 20% flavour preparation,
0 to 2% natural flavour,
0 to 1% colour,
0 to 1% stabilizer/emulsifier.

The dessert component contains one carbohydrate or a mix of carbohydrates. Carbohydrates include any polymer of glucose (dextrose) and/or fructose including sucrose and starch/inuline hydrolysates as invert sugar, glucose, maltose, fructose syrups from any origin, any polymer or derivate such as polydextrose, oligosaccharides.

The term carbohydrates in the present invention does not include sugar alcohols such as sorbitol, xylitol, mannitol, maltitol or other polyol compounds such as glycerol or propylene glycol. The term carbohydrates further does not include substances as Maltodextrins which are integrated in ingredients to optimize the rheological properties.

The dessert component may contain in addition any ingredient or combination of ingredients which act as freezing point depressing agent which may preferably be chosen from glycerol, sorbitol, xylitol, mannitol, maltitol, lactitol, erythritol. Nevertheless according to a preferred embodiment of this invention, the use of sugar alcohols is limited, due to off-taste brought when used at high concentration, to undesirable laxative effect and to limits of the regulatory legislation.

Minor amounts of sugar alcohols, less than 5% could nevertheless be included in the product of this invention.

The dessert component may also contain any ingredient or combination of ingredients which allow to optimize its rheological properties and viscosity, to values as indicated therein which may be stabilizers, gelling agents, thickening agents and/or emulsifiers.

As flavouring preparation, the dessert component may contain natural flavouring preparations such as fruit puree, fruit pulp, fruit concentrate, alcohol, alcoholised fruit, coffee, cocoa, drink, milk based preparation, mousse, fudge, aromatic herbs, seeds, spices or any material or combination of materials having an aromatising function.

As flavour, the dessert component may contain natural flavours, natur identic flavours on any support. As colourant the dessert component may contain any food grade colouring substance or additive or any ingredient having a colouring function.

The dessert component may additionally contain any inclusions: dry inclusions, coated dry inclusions, coated wet inclusions which are not soluble in it and are capable of being dispensed on the surface of the body of frozen confection together with the liquid to produce a specific visual aspect. with examples of fruit, nuts, grains or part of them, chocolate or sugar confectionery, cereals.

In the context of the invention, the body of frozen confection may be an ice cream, a premium ice cream, a water ice, a milk ice, a sherbet, a frozen yogurt or any form of frozen confection.

The body of frozen confection may contain any inclusions or pieces: dry inclusions, coated dry inclusions, coated wet inclusions.

The body of frozen confection may be obtained by moulding, extrusion or any known freezing technology.

The invention further relates to a method for the manufacture of a composite frozen confection as described therein which comprises:
providing a first internal cavity and a second external cavity in a packaging plastic material by thermoforming,
providing a hollow tube inside the internal cavity,
filling the first cavity with the liquid dessert component,
filling the second cavity with a composition to be frozen,
sealing by means of heat or other sealing mechanisms the outer thermoformed layers to close both cavities,
freezing the packaged product.

Another method for the manufacture of a composite frozen confection of the invention as described therein comprises:
providing an internal cavity in a packaging plastic material by thermoforming, blow- or injection molding or any other production mechanism,
filling the cavity with the liquid desert component,
closing one side of the cavity by means of heat or other sealing mechanisms or by using a second component that is fixed on one side of the cavity, whereas the other side of the cavity is closed by the frozen confection,
freezing the packaged product.

The frozen confection can be manufactured in any shape and can conform to any known or imagined form. Thus it can represent a volcano, any human or animal or vegetal figure, a clown, a monster for example.

The association of a stick container with a liquid dessert component can produce a visual effect which can be a flow effect on the frozen confection surface, like a volcano; a hair effect over a clown face; a product expansion by effervescence on the surface of the frozen confection; a dispersion of solid additions at the surface of the frozen confection or a combination of the above effects.

Dispensing of the liquid dessert component over and around the surface of the frozen confection may be effected by squeezing the stick container, by pushing a plunger, by using a telescopic stick to collapse, by screwing or twisting a closure of the stick, by turning a stick part, by blowing, sucking or by using heat transfer, by eating an edible stick part or any combination of these methods.

### EXAMPLES

The present invention will be further understood from the following detailed examples and description taken in conjunction with the drawings in which parts and percentages are by weight unless stated otherwise.

In the drawings:

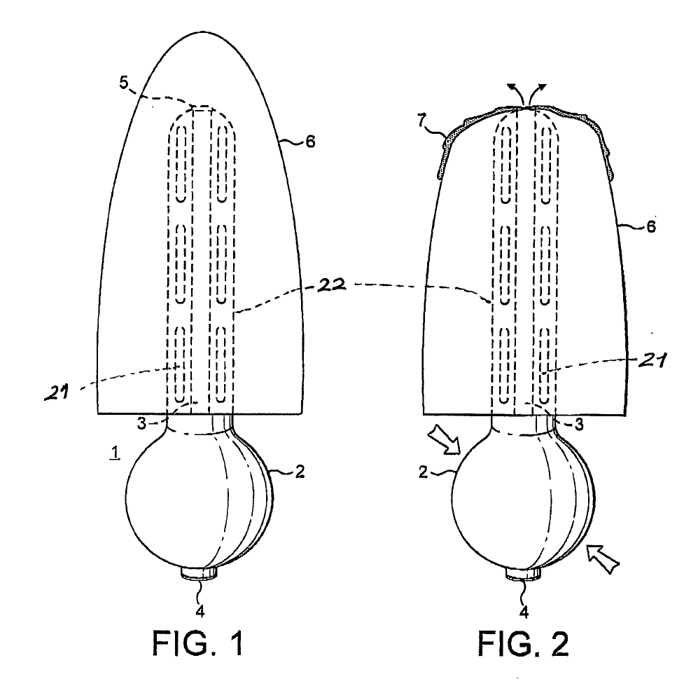

FIGS. 1 and 2 and example 1 show a moulded frozen stick bar comprising a tube and a container providing a volcano effect on consumption;

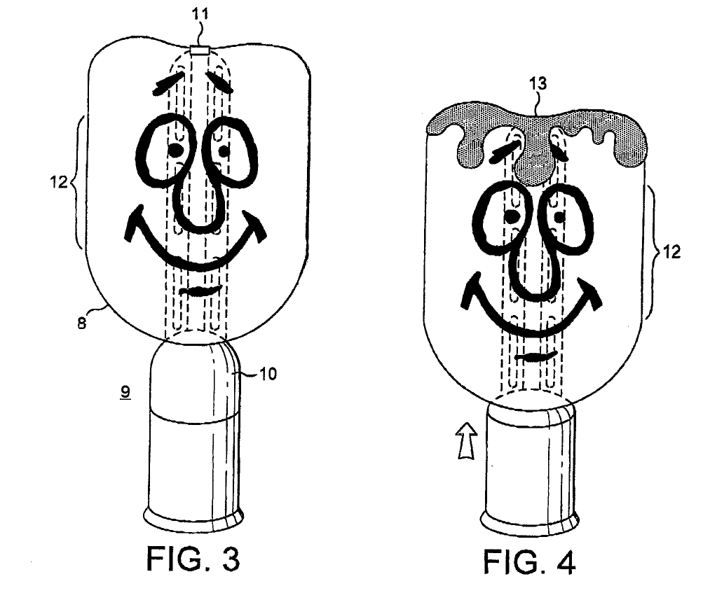

FIGS. 3 and 4 and example 2 show an extruded frozen stick bar showing a clown face with hair effect on the face on consumption wherein the stick container is provided with a push-up plunger;

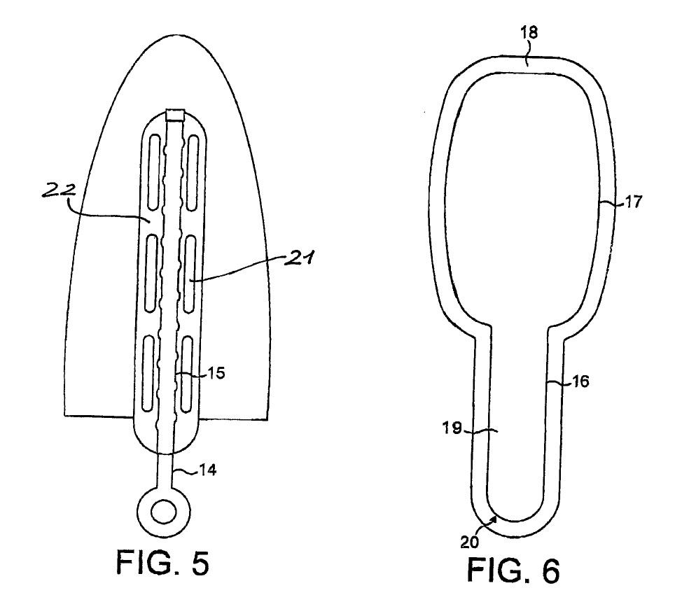

FIG. 5 shows in longitudinal section an alternative holding device with a screw and a corresponding shredded tube and the ice cream body;

FIG. 6 and example 3 show a method of manufacture of a packaged composite frozen confection.

Referring now to FIG. 1 there is shown a composite frozen confection. A stick container 1 made of one piece of blow-moulded polyethylene comprises a container 2 and a hollow tube 3. The stick container 1 is filled with a sauce of the following composition:

| Chocolate Sauce | % |
|---|---|
| Invert Sugar | 93.00 |
| Water | 5.17 |
| Cocoa Powder | 1 |
| Chocolate Flavour | 0.03 |
| Caramel Colour | 0.80 |
| | 100 |

which is liquid at temperatures higher or equal than −25° C.0

In the filling step of the container 2, the tube 3 is closed at its bottom with a plastic plug 4 and at its top with a plug 5 made of chocolate.

A body 6 of frozen confection is made by filling a mould with an ice cream of standard composition, inserting the filled stick container 1 and freezing in a refrigerated environment.

As shown in FIG. 2, after the first lick or the first bite, the consumer squeezes the flexible container 2 and dispenses the sauce 7 that flows over the frozen confection body 6.

Referring to FIG. 3, a body of frozen confection 8 is extruded vertically. A stick container 9 in the form of a push-up stick in two parts made of injection-molded polypropylene is filled with a sauce 10, closed with a chocolate plug 11 and inserted horizontally into the center of the frozen confection extrudate at regular intervals, which is cut into slices. The frozen confection slice with the stick inserted herein is going on a conveyor plate.

A design 12 figuring a clown face is printed on the surface of the slice using chocolate as printing ink. After hardening in a tunnel the product is packed in a flow-wrap.

As indicated in FIGS. 3, 4, after the first lick or the first bite and taken away the plug the consumer acts on the hollow push-up tube and forces the sauce out of the stick container, which sauce flows down from the top to figure a hair 13 of the clown face. As alternative to the shown slidable plunger, one may use a screw 14 as shown in FIG. 5 that can liberate the dessert component in a corresponding threaded tube 15.

In FIG. 6 a packed in-pack is provided by a thermoform-fill-seal method, wherein a first internal cavity 16 and a second external cavity 17 are formed by two polyethylene sheets peelably sealed together along a contour sealing 18, a hollow plastic tube 19 is inserted in the cavity 16, a liquid sauce 20 is filled into the cavity 16 through the hollow tube 19 and the tube 19 is closed by sealing. The second cavity 17 is then filled with a water ice composition, the sheets are sealed together and cut and the product is hardened in a refrigerated or freezing environment.

For consumption, the packaging is opened through the edges, the sauce is ejected from the pack by squeezing, twisting or another method and pushed at the surface of the frozen body, creating a visual effect.

For ice lolly manufacturing the filled stick container is inserted into the ice cream body (made by extrusion or moulding). The stick container comprising the container 2,10 and a tail 22 is anchored into the ice cream body with the aid of holes 21 in the tail 22; ribs on the external surface of the stick tail can fulfill the same anchoring function.

As an alternative embodiment the stick container may be filled with the liquid dessert component during the frozen confection moulding process and in this latter case the frozen confection itself serves to close the stick container at its tail end.

1. Holding device for a frozen confection in the form of a stick container filled with a dessert component that is a liquid at a low temperature, the stick container being closed by a closure element and the stick container is capable of dispensing the dessert component on the surface of the frozen confection by reducing an internal volume of the stick container after removal of the closure element.

2. Holding device according to claim 1, wherein at least some parts of the holding device are constructed from a material selected from the group consisting of flexible and rigid food grade non-edible material and edible material.

3. Holding device according to claim 2, wherein the nonedible materials comprise plastics.

4. Holding device according to claim 2, comprising an edible material selected from the group consisting of a sugar confectionery, a liquorice, a chewing gum, a chocolate coated hard candy, a pastry, and a chocolate coated biscuit tube.

5. Holding device according to claim 1, comprising a hollow element comprising a bulb part which serves as a container for the dessert component which is to be dispensed.

6. Holding device according to claim 1, comprising at least two parts which are assembled together.

7. Holding device according to claim 1, wherein the dessert component is selected from the group consisting of a sauce, a syrup, a jelly, honey, an alcohol, a carbonated drink, a fizzy drink and a mousse.

8. Composite frozen confection comprising:
a frozen confection holding device in the form of a stick container filled with a dessert component that is liquid at a negative temperature and
a body of frozen confection which is supported by the stick filled with the dessert component and in which the stick is anchored.

9. Composite frozen confection according to claim 8, wherein the dessert component is formulated to have specific rheological and mechanical properties.

10. Composite frozen confection according to claim 8, wherein the dessert component presents a Melting Temperature Range as measured by DSC, Cristallization-Melting Isotherm Tests of −16 to −40° C.

11. Composite frozen confection according to claim 8, wherein the dessert component presents mechanical properties that does not show or shows low dilatation-contraction properties in an extended range of temperatures.

12. Composite frozen confection according to claim 8, wherein the dessert component is a sauce or syrup which contains by weight:
0 to 20% water,
30 to 95% carbohydrates,
0 to 20% flavour preparations,
0 to 2% natural flavour,
0 to 1% colorant,
0 to 5% freezing point depressing agent, and
0 to 1% stabiliser/emulsifier agent.

13. Method for the manufacture of a composite frozen confection comprising:
providing a first internal cavity and a second external cavity in a packaging plastic material by thermoforming,
providing a hollow tube inside the internal cavity of the package,
filling the first cavity with the liquid dessert component,
filling the second cavity with a composition to be frozen,
sealing the outer thermoformed layers to close both cavities, and
freezing the packaged product.

14. Method for the manufacture of a composite frozen confection comprising:
providing an internal cavity in a packaging plastic material,
filling the cavity with the liquid dessert component,
closing one side of the cavity, and
freezing a packaged product.

15. Method for producing a visual effect on a frozen confection upon consumption which comprises expelling a liquid dessert composition from a stick container by reducing the internal volume of the container and which can be a flow effect on the frozen confection surface.

16. Method for dispensing a liquid dessert component over and around the surface of a frozen confection comprising a holding device in the form of a stick container which comprises a step chosen from the steps consisting of squeezing the stick container, pushing a plunger, using a telescopic stick to collapse, screwing or twisting a closure of the stick, turning a stick part, blowing, sucking or using of heat transfer, eating an edible stick part, and combination of these methods.

17. Holding device for a frozen confection in the form of a stick container filled with a dessert component that is a liquid at a low temperature, the stick container is closed by a closure mechanism and the stick container is capable of dispensing the dessert component on the surface of the frozen confection by reducing an internal volume of the stick container after opening the closure mechanism.

18. Holding device according to claim 2, wherein the nonedible materials are selected from the group consisting of polypropylene and polyethylene.

19. Holding device according to claim 1, the dessert component comprising an inclusion which is selected from the group consisting of dry inclusions, coated dry inclusions, coated dry inclusions, coated wet inclusions with fruit, nuts, grains, chocolate, sugar confectionery and cereals.

20. Composite frozen confection according to claim 8, wherein the dessert component comprises reduced freezing/melting temperatures that are sufficiently low that the said dessert is liquid at low negative temperatures and ready to be expressed in tasting at exit of the cabinet freezer.

21. Composite frozen confection according to claim 8, wherein the dessert component is a sauce or syrup which contains by weight:
0 to 10% water,
55 to 95% carbohydrates,
0 to 20% flavour preparations,
0 to 2% natural flavour,
0 to 1% colorant,
0 to 5% freezing point depressing agent,
0 to 1% stabilizer/emulsifier agent.
